(19) United States
(12) Patent Application Publication
(10) Pub. No.: US 2005/0081721 A1
(43) Pub. Date: Apr. 21, 2005

(54) Barbecue grill and hinge

(76) Inventors: Paul Craycraft, Marion, OH (US); Keith Ray, Delaware, OH (US); Lee M. Sisler, Marion, OH (US)

Correspondence Address: MOORE, HANSEN & SUMNER, PLLP, 225 SOUTH SIXTH ST, MINNEAPOLIS, MN, 55402, US

(21) Appl. No.: 10/926,756

(22) Filed: Aug. 26, 2004

Related U.S. Application Data
(60) Provisional application No. 60/512,172, filed on Oct. 17, 2003.

(51) Int. Cl. A47J 9/00

(52) U.S. Cl. 99/450

(57) ABSTRACT

An outdoor cooking appliance, such as a “Barbeque Grill”, having a body and a lid. The lid is connected to the body by a hinge assembly and is movable between a first, closed position and a second, open position. As the lid is moved between the first and second positions, the hinge assembly counterbalances the weight of the lid so that the lid does not close of its own accord and may be positioned at one of plurality of positions intermediate between the closed and the open positions. The hinge assembly includes two arms that are pivotally interconnected. The hinge assembly preferably includes a linkage that interconnects the one of the two arms of the hinge assembly to the lid to permit the hinge to reside in a location that is relatively removed from and remote to the lid so that the hinge assembly. In a further embodiment, the hinge is adjustable.

### RELATED APPLICATIONS

The present application is related to and claims priority to U.S. Provisional Patent Application No. 60/512,172 for BARBECUE GRILL AND HINGE, filed Oct. 17, 2003.

### FIELD OF THE INVENTION

The present invention relates generally to outdoor cooking appliances. More specifically, the present invention relates to a cooking appliance of the type having a body with a receptacle and a lid, with the lid operatively connected to the body and movable with respect thereto, so that it may be moved between a closed position, where it substantially covers the receptacle, and an open position permitting access to the receptacle. Outdoor cooking appliances of this type are often called “Barbeque (BBQ) Grills”.

### BACKGROUND OF THE INVENTION

Outdoor cooking appliances or “barbeques” have been used for many years. Typically, they comprise a freestanding body and a lid. The body has a bottom and sidewalls that define an open ended receptacle into which cooking elements and/or combustible material is placed, and over which a grill, cooking surface, and/or rotisserie is positioned. The lid is configured to substantially cover the open end of the receptacle to form a cooking chamber. Often, the lid is vertically dished or domed so that it may form a cooking chamber that can accommodate large or multiple food items. In some cooking appliances, the lid is configured to be loosely positioned on the body in the manner of placing a lid on a pot, but in most instances, the lid is pivotally hinged to the body and rotatable between closed and opened positions.

In those outdoor cooking appliances with hinged lids, the lids are often only able to rest in two extreme positions, one extreme being a closed position and the other extreme being an open position, where the open position is one in which the lid is rotated slightly greater than 90 degrees to allow the lid to be pivoted over center. With such lids, if one were rotating the lid from one position to the other and accidentally let go of the lid before completely opening or closing it, it would slam shut under the force of gravity. The force of the lid slamming into the body can jar food items off the grill or cooking surface, damage the lid and/or body, and possibly cause injury to a user or perhaps someone else with their hand on the body. This is especially a possibility if the appliance is a large appliance having a substantial lid that may weigh upwards of about 30 to 40 pounds, perhaps even as much as about 70 pounds. As one may appreciate, these drawbacks become more pronounced with heavier lids.

It would be appreciated that, it is often desirable to adjust the cooking temperature of the outdoor cooking appliance. This is not always possible with those appliances that are heated by combustible material such as charcoal briquettes and/or wood chips, however, because the lid has to be opened-up and the grill or cooking surface often has to be removed in order to access to the charcoal briquettes and/or wood chips. In view of the difficulties and potential dangers involved with these steps, it is often most expedient for users to adjust the temperature by partially lifting the lid relative to the open end of the receptacle. Unfortunately, most outdoor cooking appliance lids are not capable of being positioned in a partially open position. Thus, using the position of the lid to control the temperature of the cooking chamber is often an inadequate and imprecise activity.

Therefore, it will be further appreciated that there is a need for an outdoor cooking appliance with a lid that will not close shut with great force under the influence of gravity, that may be easily positioned at one of a plurality of angles relative to the body and that is made in a manner that takes the high temperatures in the immediate vicinity of the lid into account when designing the hinge. The present invention addresses these and other needs.

### SUMMARY OF THE INVENTION

Briefly, the present invention comprises a hinge assembly suitable for use with an outdoor cooking apparatus of the type comprising a receptacle having a bottom and sidewalls that define an open end, and a lid configured to substantially cover the open end of the receptacle, the hinge assembly operatively connecting the lid to the receptacle such that the lid is movable with respect thereto between a closed position, wherein the lid substantially covers the open end of the receptacle, and a plurality of open positions in which a gap exists between the lid and at least one sidewall of the receptacle, the hinge assembly comprising: a first arm configured to be operatively connected to either one of said receptacle or said lid; a second arm configured to be operatively connected to the other one of said receptacle or said lid, wherein the first and second arm are movably connected to each other; and, means for counterbalancing the weight of the lid; whereby, when the lid is moved to one of the plurality of open positions, the lid is able to remain in such open position in the absence of external forces acting on the lid.

The invention also comprises an outdoor cooking appliance comprising: a body comprising a bottom and side walls, with the side walls defining a cooking area; a lid configured to substantially cover the cooking area to form a cooking chamber; and, a hinge assembly operatively connecting the lid to the body such that the lid may be moved from a first position where it substantially covers the cooking area of the body, and a continuum of open positions in which a gap is formed between the lid and at least one sidewall of the receptacle, the hinge assembly comprising: a first arm configured to be operatively connected to either one of said receptacle or said lid; a second arm configured to be operatively connected to the other one of said receptacle or said lid, wherein the first and second arm are movably connected to each other; and, means for counterbalancing the weight of the lid; whereby, when the lid is moved to one of the continuum of open positions, the lid is able to remain in such open position in the absence of external forces acting on the lid.

Generally, the hinge assembly comprises a first arm and a second arm, with the first and second arms operatively connected to and movable with respect to each other. The hinge assembly includes a means for counterbalancing the weight of the lid as it is rotated between the closed and open positions. The means for counterbalancing is operatively connected to the first and second arms, and is configured and arranged so that the first and second arms are biased in a first rotational direction with respect to each other. This rotational biasing allows the hinge assembly to counterbalance the weight of a lid as it is moved from the closed position to an open position. The rotational biasing also allows the lid to be positioned at a predetermined position.

To that end, the first arm comprises an elongated generally u-shaped body, an elongated generally u-shaped link, a biasing element, a post, and a follower mechanism. More specifically, the elongated u-shaped body has a first end and a second end, and comprises a rear wall, opposing sidewalls and an end wall. The first end of the body is pivotally attached to the second arm by a pin or pintle, which is inserted through apertures in the sidewalls adjacent the first end of the body and through the first aperture in the second arm. The first end of the u-shaped body also includes a slot that extends partially up the rear wall and which is configured to freely admit a portion of the second arm as the u-shaped body is pivoted relative to the second arm. The second end of the u-shaped body includes a transverse end wall having a slot that is sized to freely admit the post and allow movement with respect thereto. The transverse end wall also serves to support one end of a biasing element. As will be understood, the first arm may be operatively connected to either one of the lid or the body of the cooking appliance.

The elongate u-shaped link of the hinge assembly also has a first end and a second end, and comprises a front wall and opposing sidewalls. The u-shaped link is pivotally attached to the second arm by a second pin or pintle, which is inserted through apertures in the sidewalls adjacent the first end of the u-shaped link and through the second aperture of the second arm. Note that the second aperture of the second arm is spaced from the first aperture second arm by a predetermined distance. The u-shaped link is also configured so that it may be positioned between the sidewalls of the u-shaped body and movable with respect thereto in a constrained manner as the first and second arms pivot with respect to each other. The sidewalls adjacent the second end of the u-shaped link are provided with apertures or through holes that are configured to receive a crossbar, which is used to engage one end of the post.

The elongated, generally u-shaped post has a first end and a second ends, and comprises a rear wall and opposing sidewalls. The sidewalls of the first end of the u-shaped post are provided with slots or notches that are configured to engage the crossbar that is inserted into the sidewall apertures of the u-shaped link. The second end of the post includes an enlarged head that is sized to engage an end of the biasing element and prevent passage thereby.

Alternatively, the elongated u-shaped post may be provided with an adjustment member. The adjustment member comprises an elongated shaft having first and second ends, and is provided with a transverse aperture that is sized to accept a crossbar that is inserted through appropriately sized apertures in the second end of the u-shaped post. The second end of the adjustment member includes an adjustable stop that is used to vary the effective working length the u-shaped post. In use, a spring is positioned over the u-shaped post such that one end abuts the transverse end wall of the u-shaped housing. The adjustable stop is then positioned on the threaded end of the adjustment member and the nut is tightened or loosened to the desired degree. Thus, the hinge may be adjusted to counterbalance differently sized lids.

The follower mechanism comprises a roller that is operatively connected to a first end of a second post having first and second ends. The follower mechanism is movably retained on the u-shaped body by a transverse tab, through which the second end of the post projects, and a transverse pin, which is movably retained in longitudinal slots in the sidewalls of the u-shaped body, and which also serves as an axle for the roller. The roller is urged away from the tab and towards the first end of the u-shaped body by a biasing element, which is carried by the post, and which extends between the tab and a shoulder on the first end of the second post. In operation, the slots in the sidewalls define the range of motion that is available to the roller.

The second arm of the hinge assembly comprises an attachment end, a connection end, and a camming surface. The attachment end is configured to be operatively connected to either one of the body or lid of the outdoor cooking appliance, preferably the body, while the connection end is configured to be operatively connected to the first arm of the hinge assembly such that the first and second arms can pivot with respect to each other.

The camming surface of the second arm is radially spaced from the pivot point of the connection end and is configured to contact and move the roller of the follower as the first and second arms move with respect to each other. It will be appreciated that the particular profile of the camming surface used will affect the motion of the first arm relative to the second arm. For example, the camming surface could have a spiral or involute profile. In such a case, the first arm would be urged in direction that leads to the smallest radius, due to the action of the spring-biased roller of the follower. Preferably, though, the camming surface is not an involute and includes a recess or trough into which the roller is urged as the first and second arms move with respect to each other. The trough in effect captures the roller and allows the lid be positioned at a predetermined angle with respect to the body, where it resists movement in either direction, due to the action of the follower.

In operation, the hinge assembly counteracts the weight of the lid as the lid is moved between the closed and open positions. Thus, for example, a user may position the lid at any point along a range of angles, and the lid will stay in that position, absent an external force acting there against. Preferably, the range of angles is from about 1 degree to about 65 degrees. The hinge assembly also allows the lid to be positioned at a predetermined angle, where the lid is biased from either direction toward a neutral position. Preferably, the neutral position is in the range of around 65 degrees. When the lid is moved beyond the neutral position of about 65 degrees, it swings open in a normal manner.

### BRIEF DESCRIPTION OF THE DRAWINGS

FIG. 1 is a front perspective view of an outdoor cooking appliance having a hinge assembly connecting to a lid showing the body of the cooking appliance and the lid in a closed position substantially covering the cooking area of the cooking appliance;

FIG. 2 is a front perspective view of the cooking appliance shown in FIG. 1, but showing the lid in an open position and showing the grill partially broken away;

FIG. 3 is a partial front perspective view of an outdoor cooking appliance that is the same as that shown in FIG. 1, except that an alternative lid 31 is shown that includes a cut-out 35 for a rotisserie (not shown) and the protective cover 42 of the hinge assembly 40 is exploded away to expose working parts of the hinge assembly 40;

FIG. 4 is a partial side plan view of the cooking appliance shown in FIG. 3;

FIG. 5 is a partial rear end view of the cooking appliance shown in FIG. 3;

FIG. 6A is an enlarged, partially broken away side plan view of the parts of the hinge assembly shown in FIG. 4, with a portion of the first arm broken away to show a follower mechanism, and with alternate positions of the first arm relative to the second arm shown in dashed lines as the first arm is moved from the closed position to rest alternatively at a partially open position and a fully open position at its maximum open extent;

FIG. 6B is an enlarged partial side plan view of the follower mechanism as it resides within the housing of the hinge assembly;

FIG. 6C is a partial side plan view of an alternate embodiment of a post having an adjustable end so that the spring biasing force counter balancing the weight of the lid can be adjusted;

FIG. 7 is a front perspective view of a further embodiment of a cooking appliance 10′, which is the same as the embodiment shown in FIG. 3, except that the body 12 has been enlarged and an alternate hinge assembly is provided at a more remote location on the cooking appliance in relation the location of the receptacle 20 and the hinge assembly 188 includes a linkage 182 to interconnect the hinge assembly to the lid 31; and,

FIG. 8 is a front perspective view of the embodiment shown in FIG. 7, in which the lid has been moved from the closed position to an open position at its maximum open extent.

### DESCRIPTION OF THE PREFERRED EMBODIMENT

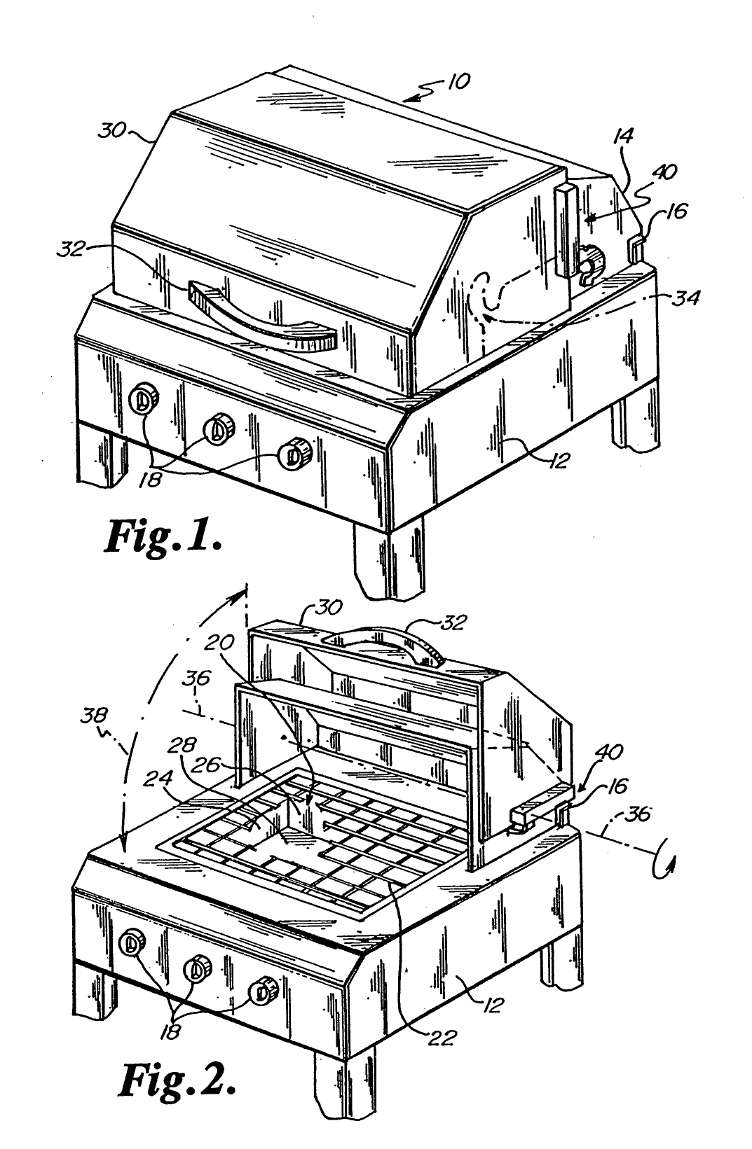

Referring now to FIGS. 1 and 2 an outdoor cooking appliance 10 of the type having a body 12 and a movable lid 30 is depicted. Preferably, the outdoor cooking appliance 10 is a barbeque grill of the type shown having a receptacle 20 for receiving and retaining combustible materials such as charcoal or wood (not shown). The receptacle or a cooking area 20 is covered by the lid 30 to form a covered cooking chamber when the lid 30 is in the closed position so that a greater percentage of any heat generated by burning combustible material (not shown) is retained in the cooking chamber. It will be appreciated that while the embodiment of the cooking appliance 10 shown in FIGS. 1 and 2 includes a conventional receptacle 20 for combustible materials (not shown), other common features that are not shown may be included, such as, without limit, a conventional support with an array of apertures, a solid cooking surface, a rotisserie or the like. As shown, the body 12 of the cooking appliance 10 includes a rear cowl 14 that extends upwardly and forwardly relative to the cooking surface to define a cavity, which forms a portion of a cooking chamber. The rear cowl 14 also includes one or more stops 16 attached thereto. Although not shown, preferred embodiments will have a second stop on the side opposite the first stop 16. The body 12 also includes one or more dials 18 to control heating elements within the interior of the body (not shown). It will be understood, however, that controllable heating elements are not necessary to practice the present invention and that the cooking appliance 10 may be of the type that solely utilizes wood chips, charcoal briquettes or the like to provide a source of heat.

The lid 30 may be provided with a handle 32 or similar device, so that a user of the grill may manipulate the lid 30 with relative ease and comfort. It will be appreciated that the particular lid configuration depicted is not necessary to practice the invention and that other types of lids may be used without departing from the spirit and scope of the invention. For example, the lid 30 may be formed with a cutout 34 (shown in dashed lines in FIG. 1) that is configured to accommodate the rotating spit of a rotisserie (also not shown).

As shown in FIGS. 1 and 2, hinge assembly 40 is operatively connected both to the rear cowl 14 of the body 12 and a lid 30. In FIG. 2, the lid 30 has been rotated from the closed position to an open position, where the lid has been rotated about pivot axis 36 by about 90 degrees. Note that the lid 30 is prevented from rotating too far over center by the stop 16 attached to a side of the rear cowl 14. With the lid 30 in the open position the components of the body may be more easily seen. As with conventional cooking appliances, a grill 22, which supports food (not shown) over a heat source (not shown), is configured to cover the receptacle 20 of the body 12. The receptacle 20 comprises a plurality of side walls 24, 26, and a bottom 28, which house a source of heat (not shown) and partially define the receptacle 20. Although the side walls 24, 26, and bottom 28 are depicted as planar, it will be appreciated that other configurations are possible and that the receptacle 20 may be rounded or concave without departing from the spirit and scope of the invention. As will be appreciated, the grill 22 may be replaced with a cooking surface such as a griddle, or may include a rotisserie of the type having a horizontal, rotatably mounted spit.

When the lid 30 is moved between the closed and open positions, the lid is rotated about a pivot axis 36 that is formed by the hinge assembly 40 such that the lid 30 has an angular range of movement 38. Preferably, the angular range of movement 38 from a closed resting position such as that shown in FIG. 1 is about 0 degrees when the lid 30 is in the closed position and about 90 degrees when the lid has been moved to the open position shown in FIG. 2.

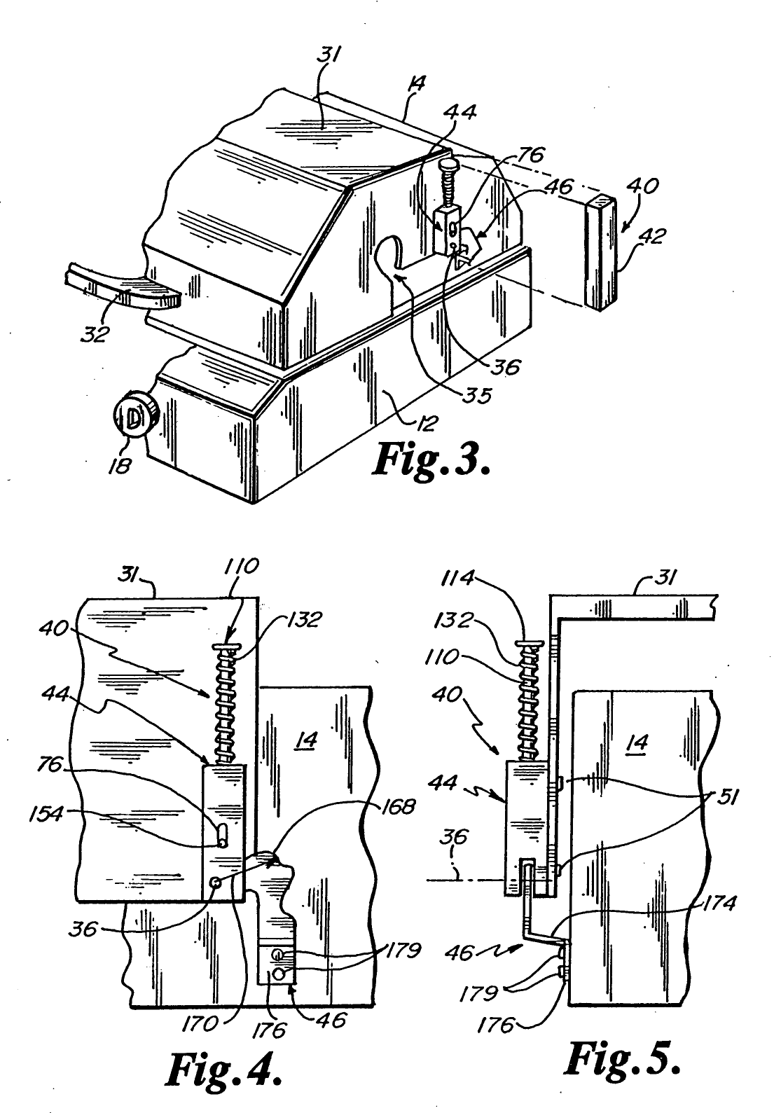

Referring now to FIGS. 3, 4, and 5, which show partial views of the same cooking application 10 shown in FIGS. 1 and 2, except that the lid 31, differs from the lid 30 shown in FIGS. 1 and 2 because it includes a cut out 35 for a rotisserie (not shown). The hinge assembly 40 includes a cover 42, which removably fits over a first arm 44 to protect the first arm from heat, dust and dirt, inclement weather and the like. The cover 42 is removably attached to the first arm by conventional fasteners, such as clips, threaded fastener, or the like (not shown). In this embodiment, the first arm 44 is positioned adjacent a rear end of the lid 31, in a substantially vertical position. The first arm 44 is operatively connected to a lid 31 by conventional fasteners 51 such as threaded fasteners, clips or the like (see FIG. 5);

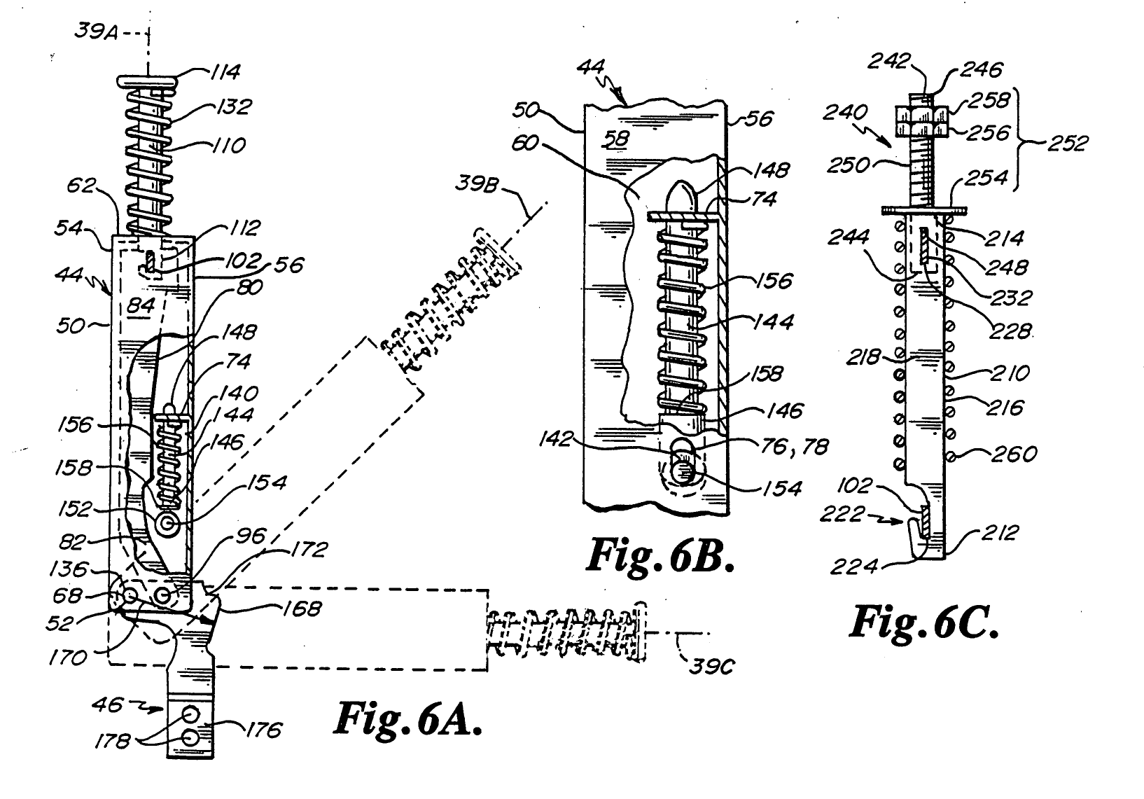

As can be seen in FIGS. 4 and 5, the hinge assembly 40 also includes a second arm 46, to which the first arm 44 is operatively connected in a manner in which the first and second arm may rotate relative to each other. The second arm 46 is removably attached to the rear cowl 14 of the body 12 by conventional fasteners 179 such as threaded fasteners, clips, or the like. As can be seen in FIG. 5, the lid 30 has larger dimensions than the rear cowl 14. Thus, the second arm 46 is provided with an offset 174 and a foot 176 that bring the second arm 46 into alignment with the first arm 44. The foot 176 includes attachment points 178 (see FIG. 6A) that are configured to accept conventional fasteners 179 such as threaded fasteners, clips, or the like. It will be appreciated that the positions of the first and second arms may be reversed without departing from the spirit and scope of the invention. Thus, for example, the first arm may be attached to the rear cowl while the second arm may be attached to the lid in a manner that still allows the lid 31 to pivot with respect to the rear cowl 14 and the body 12.

Referring now also to FIG. 6A, the hinge assembly 40 will now be discussed in greater detail, starting with the first arm 44. The first arm 44 comprises an elongated generally u-shaped body 50, an elongated generally u-shaped link 80, a post 110, a means for counterbalancing the weight of the lid, and a follower 140. The elongated u-shaped body 50 has a first end 52 and a second end 54, and comprises a rear wall 56, opposing sidewalls 58, 60 and an end wall 62. The first end 52 of the body 50 is pivotally attached to the second arm 46 by a pivot pin or pintle 68, which is inserted through apertures in the sidewalls adjacent the first end 52 of the body 50 and through a first aperture in the second arm 46. The first end 52 of the body 50 also includes a slot that extends partially up the rear wall 56 and which is configured to freely admit a portion of the second arm 46 as the body 50 is pivoted about the pintle 68. The second end 54 of the body 50 includes a transverse end wall 62 having a slot that is sized to freely admit a post 110 and allow movement with respect thereto. The transverse end wall 62 also supports one end of the biasing element 132.

The elongated generally u-shaped link 80 of the hinge assembly 40 also has a first end 82 and a second end 84, and comprises a front wall and opposing sidewalls. The u-shaped link 80 is pivotally attached to the second arm 46 by a pintle or pin 96, which is inserted through apertures in the sidewalls adjacent the first end 82 of the u-shaped link 80 and through a second aperture in the second arm 46. The u-shaped link 80 is also configured so that it may be positioned between the sidewalls 58, 60 of the u-shaped body 50 and movable with respect thereto in a constrained manner as the hinge assembly 40 is pivoted about the pivot pins 68 and 96. The sidewalls adjacent the second end 84 of the u-shaped link 80 are provided with apertures or through holes that are configured to receive a crossbar, which is used to engage a first end 112 of the post 110.

The elongated, generally u-shaped post 110 has a first end 112 and a second end 114, and comprises a rear wall and opposing sidewalls. The sidewalls of the first end 112 of the u-shaped post 110 are provided with a crossbar engagement member, which comprises slots that are configured to engage a crossbar that is inserted into the sidewall apertures or through holes of the u-shaped link 80.

The mechanism for counterbalancing the lid is operatively connected between the first and second arms. Preferably, the means for counterbalancing comprises a biasing element such as a compression spring. However, it is understood that other devices such as counterweights, pneumatic assists, electric motors, and the like, may be used without departing from the spirit and scope of the invention.

The second arm 46 has two pivot points represented by two transverse apertures. The first aperture is configured to receive pintle 68, which extends through the side walls of the u-shaped housing, and which allows the first arm 50 to pivot relative to the second arm 46. The second transverse aperture is configured to receive pintle 96, which extends through the side walls of the u-shaped link 80, and which allows the u-shaped link 80 to also pivot relative to the second arm 46. As the first and second arms rotate, the tip of the post 114 will describe an arc that is off-center with the arc described by the end wall 62 of the u-shaped housing 50. This causes the distance between the end 62 of the housing and the end 114 of the post to change, which results in the force exerted by the biasing element to change. It will be appreciated that such change will counteract the moment arm generated by the lid as it is pivoted between the closed and open positions.

The second arm 46 also includes a camming surface 168 that is spaced radially from the first aperture or pintle 68. The camming surface 168 is configured to contact the roller 142 of the follower mechanism 140 and such that the roller 142 compresses the biasing element 156 in a predetermined manner. The camming surface 168 is primarily used to provide the lid with a set point relative to the horizontal. Preferably, this set point is about 65 degrees with respect to the horizontal and is represented by a trough or capture point 172, which is bounded by raised areas of the camming surface 168. As will be appreciated the set point may be located at other angles relative to the horizontal. Moreover, it will be appreciated that the camming surface may be provided with more than one set point, if desired.

Referring now also to FIG. 6B, the follower mechanism 140 is operatively connected to the u-shaped housing 50 and is movable in a constrained manner with respect thereto. The follower mechanism 140 comprises a roller 152 that is operatively connected to a first end of a second post 144 having first and second ends 146 and 148. The follower mechanism 140 is movably retained on the u-shaped body 50 by a transverse tab 74, through which the second end 148 of the post 144 projects, and a transverse pin 154, which is movably retained in longitudinal slots 76, and 78 in the sidewalls of the u-shaped body 50, and which also serves as an axle for the roller 152. The roller 152 is urged away from the tab 74 and towards the first end 52 of the u-shaped body 50 by a biasing element 156, which is carried by the post 144, and which extends between the tab 74 and a shoulder 158 on the first end 146 of the post 144. In operation, the slots 76 and 78 in the sidewalls define the range of motion that is available to the roller 152.

Referring now also to FIG. 6C, an alternate embodiment of the elongated, generally u-shaped post 110 shown in FIG. 6A is shown that allows the hinge assembly to be adjustable in the same manner as the hinge disclosed in the U.S. patent application Ser. No. 10/263,977 filed Oct. 3, 2002, the disclosure of which is hereby incorporated herein by reference. The alternate elongated, generally u-shaped post 210 has a first end 212 and a second end 214, and has a rear wall 216 and opposing sidewalls 218, 220 (note that sidewall 220 is obscured by sidewall 218). The sidewalls 218, 220 of the first end 212 of the u-shaped post 210 are provided with a crossbar engagement member 222 that includes slots 224 and 226 (note that slot 226 is obscured by slot 224), which are configured to engage the crossbar 102 that is inserted into the sidewall apertures or through holes 98, 100 of the u-shaped link 80. The u-shaped post 210 is also configured so that it may be positioned between the sidewalls 88, 90 of the u-shaped link. The sidewalls 218, 220 at the second end 214 of the post 210 likewise are provided with apertures 228 and 230 (note that aperture 130 is obscured by aperture 128), which are configured to engage a crossbar 232 that operatively connects an adjustment member 240 to the post 210.

The adjustment member 240 includes an elongated shaft 242 having first and second ends 244 and 246, respectively. The first end 244 is provided with a transverse aperture 248 that is sized to accept the crossbar 232 that is inserted through the apertures 228 and 230 in the second end 214 of the u-shaped post 210. The second end 246 of the shaft 242 is threaded 250. The adjustment member 240 also has an adjustable stop 252, which preferably includes a retainer 254 or washer and a pair of threaded fasteners or nuts 256 and 258. In use, a biasing element or spring 260 is positioned over the u-shaped post 210 such that it is held between the transverse end wall 62 of the u-shaped housing 50 and the retainer 254 of the adjustable stop 252 (see, for example FIG. 6A). As shown in FIG. 6C, it is notable that the biasing element 260 is loosely positioned about the u-shaped post 210 and is not compressed as it would be in actual use (see, FIG. 6A). Preferably, the retainer 254 is held in position by a nut 256 that engages the thread 250 of shaft 242. As will be appreciated, the nut 256 permits the length of the post 210 to be infinitely varied as it traverses the thread 250. The nut 156 may be locked into position by drawing a second nut 258 tightly against it. Thus, the hinge may be adjusted to counterbalance an oven door.

The hinge assembly 40, as depicted in FIG. 6A, illustrates a typical range of motion as the arms are pivoted relative to each other. The first arm 44 is shown in a substantially vertical position 39A as it may appear when attached to a lid of a cooking appliance. In this position, the lid would substantially cover the cooking area of the cooking appliance and would correspond to an angular range of movement from the closed position of 0 degrees. As the lid is moved between the closed position 39A and the maximum open position 39C, the hinge assembly 40 counteracts the weight of the lid. Thus, for example, a user may stop the lid at any point along a range (or continuum) of angles, say at intermediate position 39B, and the lid will remain in that position absent an external force acting there against. Preferably, the range of angles is a continuum from about 1 degree to about 65 degrees. The hinge assembly 40 also allows the lid to be positioned at a predetermined angle, where the lid is biased from either direction toward a neutral position. Preferably, the neutral position is represented by a trough or capture point 172 in the second arm 46, and is in the range of about 65 degrees. When the lid is moved beyond the trough or capture point 172 of about 65 degrees, it swings open in a normal manner.

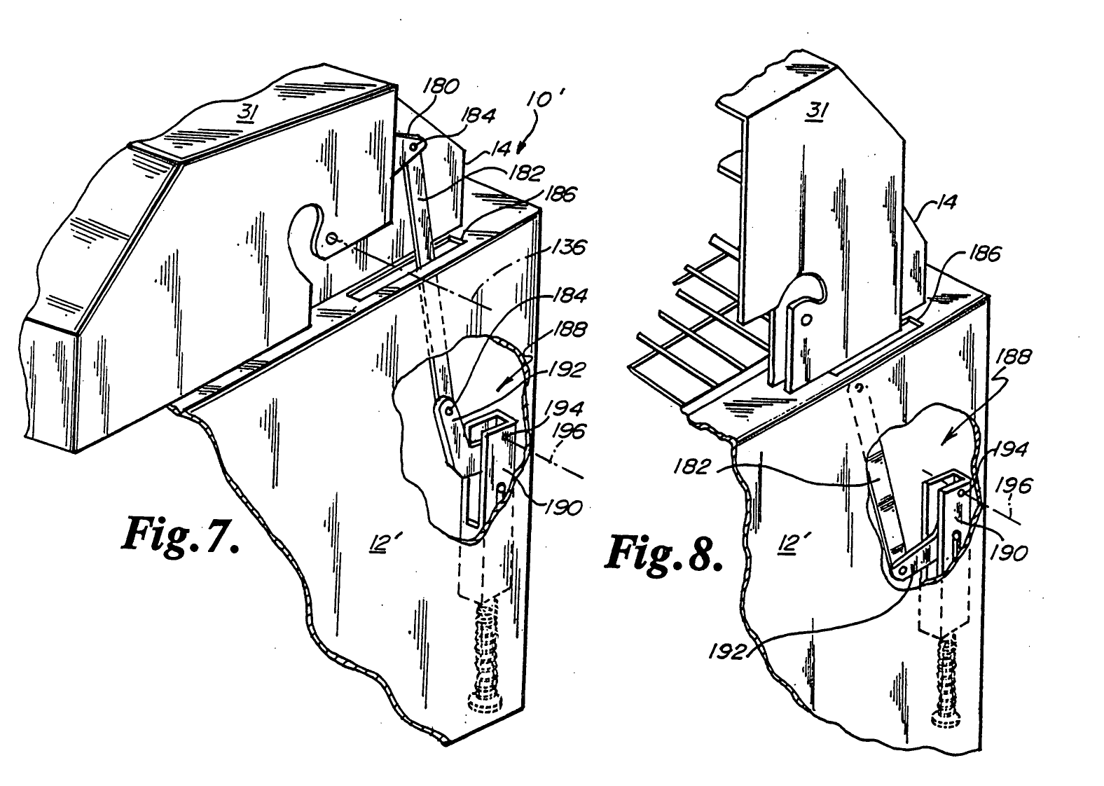

In order to remove the hinge assembly from the receptacle 20 so that the hinge assembly is not subjected to as much heat as it may be when it is located adjacent to the lid and the rear cowl as shown in FIGS. 1-5, the hinge assembly may be located in a position that is further removed from the receptacle 20 and the lid 30, 31 and the rear cowl 14 and connected to the lid 31 and body 12 as depicted in FIGS. 7 and 8. Here, a hinge assembly 188 is attached at a remote location on the alternate cooking appliance 10′. The remote location is preferred because during operation of the cooking appliance 10′, when the lid 31 is in the closed position, temperatures inside the cooking chamber rise to well over 300 degrees Fahrenheit and can often reach as high as 1,000 degrees Fahrenheit. This superheated air generally exits the closed cooking chamber between the spacing between the lid 31 and the rear cowl 14 and indirectly heats the hinge assembly 40 in the embodiments of the present invention shown in FIGS. 1-5. As will be appreciated, extended elevated temperatures are detrimental to the hinge assembly because such temperatures shorten the life of lubricants used to reduce friction between moving parts and, most critically, because such temperatures expand the metal parts of the hinge and may weaken the parts. These extended elevated temperatures generally require the parts to be made out of materials that are more expensive than what might otherwise be required if the hinge assembly were more removed from the receptacle 20 so that the temperature in the location of the hinge assembly would remain below about 300° F., preferably about 275° F., more preferably about 250° F.

As can be seen in FIGS. 7 and 8, a first arm 190 of the alternate hinge assembly 188 is operatively connected to the body 12′ of the cooking appliance 10′, while a second arm 192 is operatively connected to a lid 31 by a linkage 182. The operative connection between the lid 31 and the second arm 192 is achieved by a bracket 180 and the linkage 182, wherein the linkage 182 passes through a slot 186 in the body 12 to the second arm 192. With this embodiment, the lid 31 is pivotally attached to the rear cowl 14 by a pintle 134 having a pivot axis 136. The first and second arms 190, 192 of the hinge assembly 188, meanwhile, are pivotally connected by pintle 194 having a pivot axis 196. The connection between the u-shaped link and the second aperture of the second arm is not shown or described because it is substantially the same as shown and described in FIGS. 6A and 6B.

It will be appreciated that the drawings are modified for simplicity, but that the first arm 190 is secured to the body 12′ by thread fasteners (not shown) or such other means as may be selected. It will also be appreciated, that while the embodiment shown in FIGS. 7 and 8 show the second arm 192 being interconnected to the lid 31 by the linkage 182, the hinge assembly 188 can be easily rearranged so that the second arm 192 is secured to the body 12′ in a manner similar to the way the second arm 46 is secured to the rear cowl 14 in the embodiment shown in FIGS. 1-5, and the first arm 190 can then be interconnected with the lid 31 by the linkage without departing from the spirit or the scope of the present invention.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims, which form a further part of the present application.

1. A hinge assembly suitable for use with an outdoor cooking apparatus of the type including a receptacle having a bottom and sidewalls that define an open end, and a lid configured to substantially cover the open end of the receptacle, the hinge assembly operatively connecting the lid to the receptacle such that the lid is movable with respect thereto between a closed position, wherein the lid substantially covers the open end of the receptacle, and a plurality of open positions in which a gap exists between the lid and at least one sidewall of the receptacle, the hinge assembly comprising:
a first arm configured to be operatively connected to either one of said receptacle or said lid;
a second arm configured to be operatively connected to the other one of said receptacle or said lid, wherein the first and second arm are movably connected to each other; and,
means for counterbalancing the weight of the lid;
whereby, when the lid is moved to one of the plurality of open positions, the lid is able to remain in such open position in the absence of external forces acting on the lid.

2. The hinge assembly of claim 1, wherein the first and second arms are pivotally connected to each other and rotatable with respect thereto so that each arm can stand at an angle with respect to the other of from about 0 to an angle of about 90 degrees, wherein the angle between the respective first and second arms is about zero degrees when the lid is in the closed position and the angle between the respective first and second arms is from about 5 to about 90 degrees when the lid is in any of the plurality of open positions.

3. The hinge assembly of claim 1, wherein the first and second arms are pivotally connected to each other and axially rotatable relative to each other, the first and second arms defining a first angular relation when the lid is in the closed position, and a second angular relation when the lid is in one of the plurality of open positions, with the difference between the first and second angular relations having a range of about 0 to 90 degrees, wherein the difference between the respective first and second arms is about 0 degrees when the lid is in the closed position and wherein the difference between the respective first and second arms is from about 5 to about 90 degrees when the lid is in any of the plurality of open positions.

4. A hinge assembly for use with a barbeque grill of the type comprising a receptacle having a bottom and side walls that define a cooking area, and a lid configured to substantially cover the cooking area of the receptacle, the hinge assembly operatively connecting the lid to the receptacle such that the lid is movable under the force of gravity from an open position to a closed position, the hinge assembly comprising:
a first arm configured to be operatively connected to either one of said receptacle or said lid;
a second arm configured to be operatively connected to the other one of said receptacle or said lid, with the first and second arm movably connected to each other such that said lid is able to move between the closed position and the open position relative to the receptacle; and,
means for counterbalancing the weight of the lid;
whereby, when the lid is moved to an open position, it is able to resist the force of gravity exerted on the lid and remain in the open position in the absence of external forces.

5. The hinge assembly of claim 4, wherein the first and second arms pivot with respect to each other.

6. The hinge assembly of claim 5, wherein said means for counterbalancing the weight of the lid comprises a biasing element, the biasing element operatively connected to the first and second arms, the biasing element configured and arranged to exert a variable force between the first and second arms as the first and second arms pivot with respect to each other.

7. The hinge assembly of claim 6, wherein the biasing element is a compression spring.

8. The hinge assembly of claim 4, further comprising a means for retaining the lid at a predetermined location between its closed and open positions, wherein when the lid is moved to the predetermined location, the means for retaining the lid is able to prevent the lid from moving towards either of the closed or open positions in the absence of external forces acting on the lid.

9. The hinge assembly of claim 8, wherein the means for retaining the lid comprises a camming surface and a follower, wherein the follower is operatively connected to one of said first or second arms, wherein the camming surface is located on the other of said first or second arms, and wherein the follower is configured and arranged to contact the camming surface as the first and second arms pivot with respect to each other.

10. The hinge assembly of claim 9, wherein the camming surface has a recessed area that captures the follower and retains the lid in the predetermined location between the closed and open positions.

11. A hinge assembly for use with an outdoor cooking apparatus of the type comprising a receptacle having a bottom and side walls that define an open end, and a lid configured to substantially cover the open end of the receptacle, the hinge assembly operatively connecting the lid to the receptacle such that the lid is movable with respect thereto between a closed position wherein the lid substantially covers the open end of the receptacle, and an open position wherein a gap is formed between the lid and the open end of the receptacle, the hinge assembly comprising:
a first arm configured to be operatively connected to either one of said receptacle or said lid;
a second arm configured to be operatively connected to the other one of said receptacle or said lid, with the first and second arm movably connected to each other; and,
a biasing element having first and second ends, the biasing element operatively connected to the first and second arms, the biasing element configured and arranged to exert a variable force between the first and second arms as the first and second arms move with respect to each other such that the weight of the lid operating under the force of gravity is effectively counterbalanced along a substantial portion of the path it takes as it moves from the closed position to the open position.

12. The hinge assembly of claim 11, further comprising a follower and a camming surface, with the follower operatively connected to one of said first or second arms, and with the camming surface located at the other of said first or second arms, the follower and the camming surface contacting each other as the first and second arm move with respect to each other, the follower and the camming surface configured and arranged to retain the lid at a predetermined position between the closed and the open positions.

13. The hinge assembly of claim 12, wherein the follower comprises a spring-loaded roller.

14. The hinge assembly of claim 11, wherein the first and second arms are connected to each other by a pivot pin.

15. The hinge assembly of claim 14 wherein the camming surface is spaced a predetermined radial distance from the pivot pin, and wherein said camming surface moves the follower as the first and second arms are moved relative to each other.

16. An outdoor cooking appliance comprising:
a body comprising a bottom and side walls, with the side walls defining a cooking area;
a lid configured to substantially cover the cooking area to form a cooking chamber; and,
a hinge assembly operatively connecting the lid to the body such that the lid may be moved from a first position where it substantially covers the cooking area of the body, and a continuum of open positions in which a gap is formed between the lid and at least one sidewall of the receptacle, the hinge assembly comprising:
a first arm configured to be operatively connected to either one of said receptacle or said lid;
a second arm configured to be operatively connected to the other one of said receptacle or said lid, wherein the first and second arm are movably connected to each other; and,
means for counterbalancing the weight of the lid;
whereby, when the lid is moved to one of the continuum of open positions, the lid is able to remain in such open position in the absence of external forces acting on the lid.

17. The outdoor cooking appliance of claim 16, wherein the first and second arms are pivotally connected to each other and wherein the lid is configured to have about 90 degrees of rotation as it is moved from the closed position to a maximum open position, with the closed position defining a first angular relation of about 0 degrees, and with the maximum open position defining a second angular relation of about 90 degrees.

18. The outdoor cooking appliance of claim 17, wherein the continuum of open positions is in the range of about 5 to 60 degrees.

19. The outdoor cooking appliance of claim 16, wherein the hinge assembly further comprises a linkage interconnecting the lid with either the first and second arms.

20. The outdoor cooking appliance of claim 16, wherein the hinge assembly is adjustable.

21. An outdoor cooking appliance comprising:
a body comprising a bottom and side walls, with the side walls defining a cooking area;
a lid configured to substantially cover the cooking area to form a cooking chamber; and,
a hinge assembly operatively connecting the lid to the body such that the lid may be moved from a first position where it substantially covers the cooking area of the body, and a continuum of open positions in which a gap is formed between the lid and at least one sidewall of the receptacle, the hinge assembly comprising:
a first arm configured to be operatively connected to either one of said receptacle or said lid;
a second arm configured to be operatively connected to the other one of said receptacle or said lid, wherein the first and second arm are movably connected to each other; and,
a biasing element having first and second ends, the biasing element operatively connected to the first and second arms, the biasing element configured and arranged to exert a variable force between the first and second arms as the first and second arms move with respect to each other such that the weight of the lid operating under the force of gravity is effectively counterbalanced along a substantial portion of the path it takes as it moves from the closed position to the open position.

22. The outdoor cooking appliance of claim 21, wherein the first and second arms are pivotally connected to each other and wherein the lid is configured to have about 90 degrees of rotation as it is moved from the closed position to a maximum open position, with the closed position defining a first angular relation of about 0 degrees, and with the maximum open position defining a second angular relation of about 90 degrees.

23. The outdoor cooking appliance of claim 22, wherein the continuum of open positions is in the range of about 5 to 60 degrees.

24. The outdoor cooking appliance of claim 21, wherein the hinge assembly further comprises a linkage interconnecting the lid with either the first and second arms.

25. The outdoor cooking appliance of claim 21, wherein the hinge assembly is adjustable.

26. A method of cooking food, comprising the steps of;
providing an outdoor cooking appliance including:
a body comprising a bottom and side walls, with the side walls defining a cooking area;
a lid configured to substantially cover the cooking area to form a cooking chamber; and,
a hinge assembly operatively connecting the lid to the body such that the lid may be moved from a first position where it substantially covers the cooking area of the body, and a continuum of open positions in which a gap is formed between the lid and at least one sidewall of the receptacle, the hinge assembly comprising:
a first arm configured to be operatively connected to either one of said receptacle or said lid;
a second arm configured to be operatively connected to the other one of said receptacle or said lid, wherein the first and second arm are movably connected to each other; and,
a biasing element having first and second ends, the biasing element operatively connected to the first and second arms, the biasing element configured and arranged to exert a variable force between the first and second arms as the first and second arms move with respect to each other such that the weight of the lid operating under the force of gravity is effectively counterbalanced along a substantial portion of the path it takes as it moves from the closed position to the open position; and when cooking the food in the outdoor cooking appliance;
the step of cooking food including placing a fuel source in the cooking area and igniting the fuel so that the fuel will generate heat;
placing the food in the cooking area and partially closing the lid so that it comes to a rest and a partially open position that is neither the same as the closed position or the open position.
